(19) United States
(12) Patent Application Publication
(10) Pub. No.: US 2016/0055300 A1
(43) Pub. Date: Feb. 25, 2016

(54) HEALTHCARE INFORMATICS SYSTEMS AND METHODS

(71) Applicant: MCKESSON CORPORATION, San Francisco, CA (US)

(72) Inventors: Ramachandran A. Ganesh, Katy, TX (US); William Lopez, The Woodlands, TX (US)

(21) Appl. No.: 14/466,449

(22) Filed: Aug. 22, 2014

(51) Int. Cl. G06F 19/00

(52) U.S. Cl. CPC G06F 19/322

(57) ABSTRACT

Provided are systems and method for dynamically maintaining a healthcare data mart and providing a healthcare report in response to receiving a request for a healthcare report from a client device. The maintaining including receiving healthcare data from a plurality of data sources, integrating the healthcare data to generate integrated healthcare data, and storing the integrated healthcare data in a healthcare database. The providing including generating (using the integrated healthcare data) a healthcare report responsive to the request, and serving the healthcare report to the client device.

### TECHNICAL FIELD

Aspects of the disclosure relate generally to healthcare informatics (HI), and more particularly, to systems and methods for generating healthcare reports based on healthcare informatics.

### BACKGROUND

Healthcare informatics (HI) involves the acquisition, storage, retrieval, and use of healthcare information. Healthcare informatics often includes the generation of healthcare reports that aid users in understanding the status of healthcare practices and treatment trends in the healthcare industry. Healthcare reports are used in various industries, including the pharmaceutical and biotech industries, to develop strategies for commercializing healthcare products and practices across product life cycles. In the context of oncology, for example, pharmaceutical manufacturers use healthcare market intelligence reports to design effective go-to-market strategies and establish timely actions targeted to improve the practice of oncology.

In some instances, healthcare reports are generated to service specific requests for information. A report for an oncology drug may be generated, for example, in response to a pharmaceutical company's request for information regarding patients' use of the drug. Unfortunately, the lead-time for generating healthcare reports can be long, extending to weeks or even months. Although these types of delays are acceptable in some circumstances, many applications are sensitive to long lead-times, especially where market dynamics change quickly and reacting to market changes is critical.

Accordingly, improved systems and methods for providing accurate and timely healthcare reports is desirable.

### BRIEF DESCRIPTION OF THE DRAWINGS

Reference will now be made to the accompanying drawings, which are not necessarily drawn to scale, and wherein:

FIG. 1 is a diagram that illustrates a healthcare informatics (HI) environment in accordance with one or more exemplary embodiments.

FIG. 2 is a block diagram that illustrates an healthcare informatics (HI) server in accordance with one or more exemplary embodiments.

FIG. 3 is a block diagram that illustrates a client device in accordance with one or more exemplary embodiments.

FIG. 4 is a flowchart that illustrates a method of managing healthcare informatics information in accordance with one or more exemplary embodiments.

FIG. 5 is a flowchart that illustrates a method of processing healthcare data in accordance with one or more exemplary embodiments.

FIG. 6 is a flowchart that illustrates a method of servicing healthcare report request in accordance with one or more exemplary embodiments.

FIG. 7 is a flowchart that illustrates a method of processing a healthcare report request in accordance with one or more exemplary embodiments.

FIG. 8 is diagram that illustrates a healthcare report in accordance with one or more exemplary embodiments.

While the invention is susceptible to various modifications and alternative forms, specific embodiments of the invention are shown by way of example in the drawings and will be described in detail herein. It should be understood, however, that the drawings and detailed description are not intended to limit the invention to the particular form disclosed, but to the contrary, are intended to cover all modifications, equivalents, and alternatives falling within the spirit and scope of the present invention as defined by the appended claims.

### DETAILED DESCRIPTION OF EXEMPLARY EMBODIMENTS

The present invention will now be described more fully hereinafter with reference to the accompanying drawings. This invention may, however, be embodied in many different forms and should not be construed as limited to the illustrated embodiments set forth herein, rather, these exemplary embodiments are provided so that this disclosure will be thorough and complete, and will fully convey the scope of the invention to those skilled in the art.

Exemplary embodiments described herein include systems and methods for generating healthcare reports based on healthcare informatics. Healthcare informatics systems may be employed by a healthcare system to maintain an up-to-date healthcare data warehouse that is capable of providing healthcare reports on-demand (e.g., provide healthcare reports in real-time or near real-time).

In some embodiments, a healthcare informatics (HI) environment includes a healthcare data warehouse that is capable of receiving and integrating healthcare data from multiple disparate data sources, and generating and distributing healthcare reports on-demand using the integrated healthcare data. The data sources may include various healthcare information sources operated by different entities. Data sources may include, for example, a claims/remittance enterprise data warehouse (EDW) data source (e.g., Lynx Total View^{SM} provided by McKesson Corporation, having headquarters in San Francisco, Calif., USA), an inventory management system data source (e.g., Lynx Mobile® provided by McKesson Corporation), an electronic health/medical record (HMR or EMR) data source (e.g., iKnowMed^{SM} provided by McKesson Corporation), a pharmacy management system data source (e.g., Enterprise-Rx® provided by McKesson Corporation, Pharmaserv® provided by McKesson Corporation, or Rx3000 provided by Pharmacy Computer Services, Inc. having offices in Grants Pass, Oreg.), sales and distribution data source, and/or the like.

In some embodiments, processing of healthcare data includes staging and integrating the healthcare data to generate a healthcare information data mart that is readily accessible for use in generating healthcare reports on-demand. In some embodiments, integration of healthcare data includes generating subject data marts including a subset of the integrated data that is related to a given subject (e.g., a data mart having integrated data relating to oncology drug ABC). This allocating of data may help to speed-up the report generation process as the healthcare data warehouse can pinpoint the most relevant data for responding to healthcare report requests relating to a given subject. The healthcare data warehouse can, for example, focus on and use the information in a data mart for the oncology drug ABC to generate a report in response to a request for a report on patients' use of oncology drug ABC.

In some embodiments, integrated data is updated dynamically, independent of received requests for healthcare reports. That is, healthcare data may be received and processed on a regular (e.g., batch) or continual (e.g., real-time or near real-time) basis to maintain an up-to-date healthcare information data mart that can be used to generate healthcare reports. Thus, for example, upon receiving a request for a report on the number of prescriptions for oncology drug ABC that were ultimately filled by patients in June of 2014, the healthcare data warehouse can simply identify relevant integrated healthcare data in the already up-to-date healthcare information data mart, generate the healthcare report using the identified data, and serve the healthcare report in real-time. Such a system may enable a user to receive reports “on-demand” (e.g., within seconds or minutes of requesting the report), as opposed to having to wait weeks or even months as is common with traditional systems (e.g., systems that require building a database of healthcare information each time a report request is received).

Although certain embodiments are described in the context of healthcare, and more specially oncology, for the purpose of illustration, it will be appreciated that the disclosed systems and methods can be employed to facilitate data warehousing and report generation in any variety of specialties and industries. For example, the technology platform/systems described herein can be employed in specialties such as rheumatology, urology, cardiology, and so forth. While these technology platform/systems are primarily applicable to the Healthcare industry, there is secondary use of such systems in the Financial Industry where financial analysts track healthcare trends. Besides, application of these technology platform/systems will be extended outside of Oncology into other specialties such as Rheumatology, Urology, Cardiology etc.

System Overview:

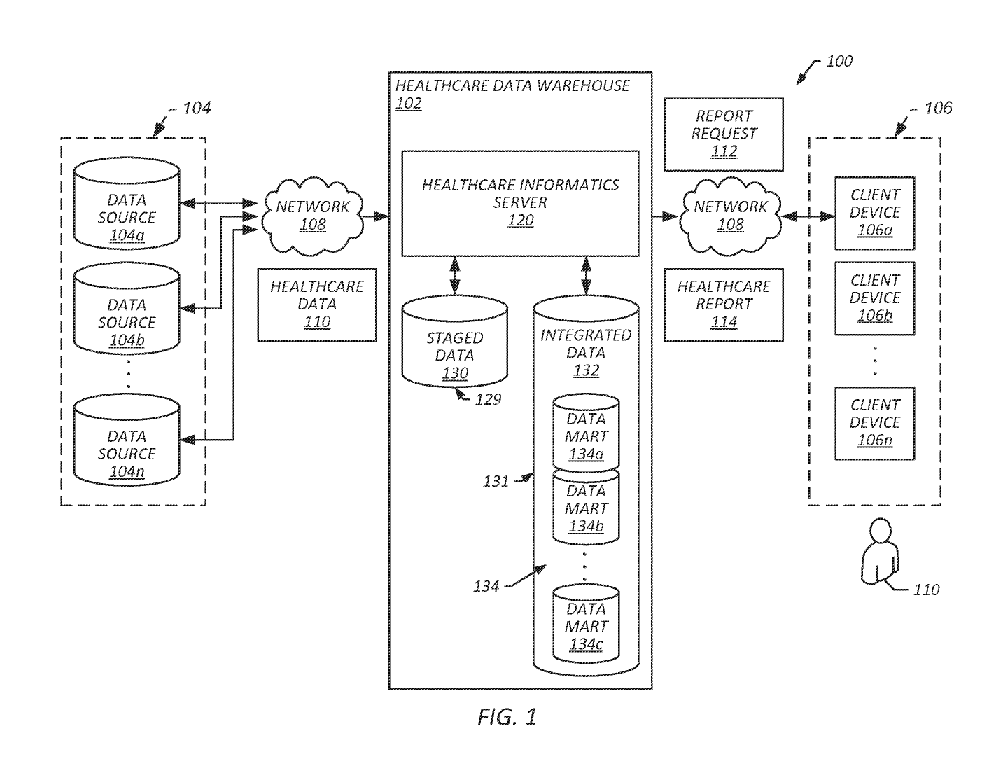

FIG. 1 is a diagram that illustrates a healthcare informatics (HI) environment 100 in accordance with one or more exemplary embodiments. As shown in FIG. 1, the HI environment 100 may include a healthcare data warehouse (“warehouse”) 102, one or more disparate data sources (“data sources”) 104 (e.g., data sources 104a-104n), and one or more disparate client devices (“clients”) 106, (e.g., client devices 106a-106n) communicatively coupled via a communications network (“network”) 108. As described herein, the HI environment 100 may be employed to provide healthcare reports to one or more users 110.

Healthcare data warehouse (“warehouse”) 102 may include a system for receiving and processing of healthcare data 110 and/or servicing report requests 112 (e.g., requests for healthcare reports 114). Healthcare data 110 may include clinical data, reimbursement data, sales data, dispensing data, and/or the like. Warehouse 102 may include a healthcare informatics server (“HI server”) 120, a staging database 129 storing staged data 130, an integrated data database (“general data mart”) 131 storing (or otherwise associated with) integrated data 132, and one or more “subject” data marts 134 (e.g., subject data marts 134a-134n) storing (or otherwise associated with) integrated data 132 related to a particular subject. A subject data mart 134 may include a subset of integrated data 132 stored in (or otherwise associated with) the general data mart 131. In some embodiments, HI Sever 120 includes general computing components and/or embedded systems optimized with specific components for performing specific tasks. HI Sever 120 may include applications/modules, including program instructions that are executable by a processor to perform some or all of the functionality described herein with regard to the HI Sever 120. Although the HI Sever 120 is illustrated as a single block for the purpose of illustration, it will be appreciated that the HI sever 120 may include a single computer device (e.g., a single server), or a plurality of computer devices (e.g., a plurality of severs, such as a server farm or distributed servers). Moreover, although databases 129 and 131 are illustrated as single blocks for the purpose of illustration, it will be appreciated that the databases 129 and 131 may include a single memory device (e.g., a single database), or a plurality of memory devices (e.g., a plurality of databases in a data center or distributed databases).

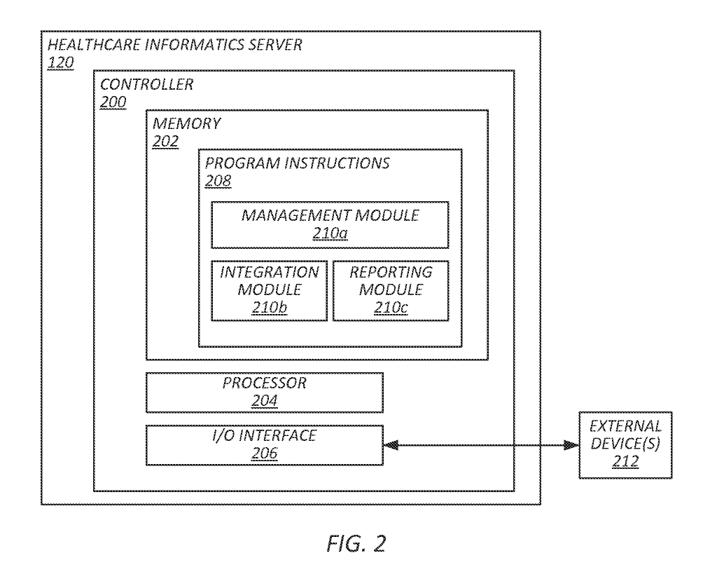

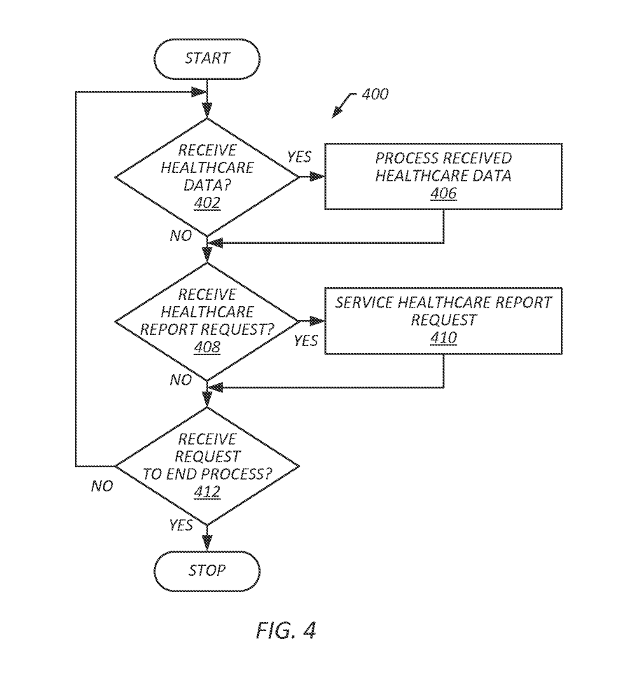

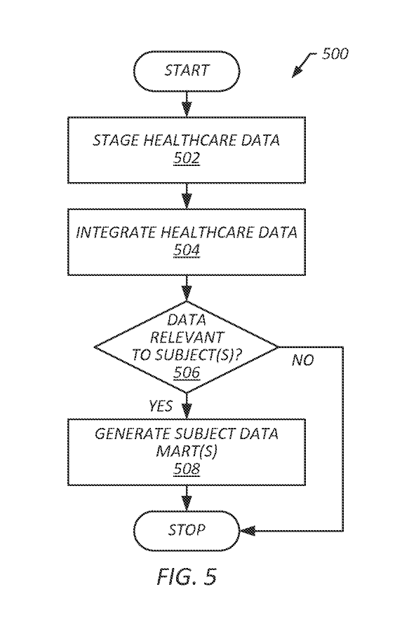

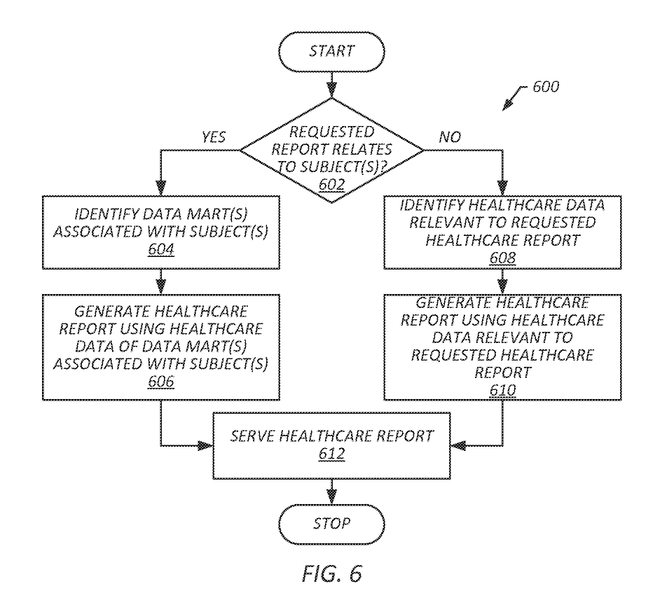

FIG. 2 is a block diagram that illustrates a healthcare informatics (HI) server 120 in accordance with one or more exemplary embodiments. In some embodiments, the HI server 120 includes a controller 200. The controller 200 may control the operational aspects of the HI server 120. In some embodiments, the controller 200 includes a memory 202, a processor 204 and an input/output (I/O) interface 206. Memory 202 may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. Memory 202 may include a non-transitory computer readable storage medium having program instructions 208 stored thereon that are executable by a computer processor (e.g., processor 204) to cause the functional operations (e.g., methods/routines/processes) described herein with regard to the HI server 120. Program instructions 208 may include software modules (e.g., including program instructions) that are executable by the processor 204 to provide some or all of the functionality described herein with regard to the HI server 120. Program instructions 208 may include a management module 210a for performing some or all of the operational aspects of a method 400 (described in more detail below with regard to FIG. 4), an integration module 210b for performing some or all of the operational aspects of a method 500 (described in more detail below wither regard to FIG. 5), and/or a reporting module 210c for performing some or all of the operational aspects of a method 600 (described in more detail below wither regard to FIG. 6).

Processor 204 may include one or more of any suitable processor capable of executing/performing program instructions. Processor 204 may include a central processing unit (CPU) that carries out program instructions (e.g., program instructions of modules 210a, 210b and/or 210c) to perform arithmetical, logical, and input/output operations of the HI server 120, including those described herein. I/O interface 206 may provide an interface for communication with one or more I/O devices and/or external device(s) 212. I/O devices may include a keyboard, a graphical user interface, a microphone, a speaker, and/or the like. External device(s) 212 may include a network 108, other network entities (e.g., data sources 104 and/or client devices 106), databases (e.g., staging database 129 and/or integrated data database 131), and/or the like. I/O devices and external devices 212 may be connected to the I/O interface 206 via a wired or wireless connection (e.g., via the network 108).

Referring to FIG. 1, data sources 104 may include any variety of sources of healthcare data 110. Data sources 104 may include one or more disparate sources of healthcare information (e.g., separate healthcare databases). Data sources 104 (e.g., data sources 104a-104n) may include, for example, a claims/remittance enterprise data warehouse (EDW) data source (e.g., Lynx Total View^{SM}), an inventory management system source (e.g., Lynx Mobile®), an electronic health/medical record source (HMR or EMR) data (e.g., iKnowMed^{SM}), a pharmacy management system (e.g., Enterprise-Rx®, Pharmaserv®, or Rx3000), sales and distribution data source, and/or the like. Healthcare data 110 may include medication dispensing records, electronic health/medical records (EHR's or EMR's), clinical payment records, clinic charges records, practice in-office dispensing records. An information record, such as that provided by, for example, Lynx Mobile® may include practice demographics (e.g., type of practice, practice location, number of practitioners in the practice, etc.), date of IV administration for the patient, patient age, patient gender, patient zip code, International Classification of Disease (ICD-9 and proposed ICD 10) diagnosis codes, chemo administered to the patient (type and amount), regimen start/end date for the patient, cycle length for the patient, duration of therapy for the patient, patient identifying information (e.g., a longitudinal de-ID patient ID that meets the requirements in the US Health Insurance Portability and Accountability Act (HIPAA) Privacy Rule), and so forth. An information record provided in an EHR/EMR, also referred to as an “EHR/EMR data description,” may include patient age, patient gender, patient zip code, patient vital signs, cancer type for the patient, comorbidities for the patient, drug regimens that the patient has and/or is currently undertaking, metastases/site for the patient, oral medications provided to the patient, IV medications for the patient, dosing cycles/duration for the patient, length of therapy for the patient, treatment intervals for the patient, tumor type for the patient, patient histology, patient bio markers, patient staging, practice demographics, longitudinal de-ID patient ID, and so forth. A clinic charge/payment record, also referred to as a “financial claims/remits data description,” may include patient age range, patient zip code, geography (e.g., city, state, country, and/or subdivision thereof), ICD-9 diagnosis code, current procedural terminology (CPT) procedure code for the patient, healthcare common procedure coding system (HCPCS) product/procedure code for procedure performed or product given to the patient, date of service, location of care provided to the patient, reported changes to the patient, payers (e.g., a health insurance provider, a pharmacy benefits manager (PBM), a Medicare payor, a Medicare Part A, B, or D payor, a Medicaid payor, an accountable care organization, or other third-party payor), payer types, referring practitioner, reimbursement rates, longitudinal de-ID patient ID, and so forth. A practice in-office dispensing record, also referred to as a “Rx IOD data description,” may include prescriber identification (e.g., prescriber first and last name, national provider identifier (NPI) code and/or drug enforcement administration (DEA) number), pharmacy identification (e.g., pharmacy name, chain number, pharmacy address, and/or NPI code), product identifier (e.g., product name, national drug code (NDC) code, and/or RxNorm number), zip code of the prescriber, pharmacy, and/or patient), prescription date written/filled, prescription number, quantity dispensed, days' supply, refill/new/switch, number of refills permitted, cost, pain, retail/non-retail/mail/specialty, longitudinal de-ID patient ID, and so forth. Healthcare data 110 (e.g., including EHR/EMR data descriptions, financial claims/remits data descriptions, and Rx IOD data descriptions) can be extracted from data sources in a variety of manners. For example, healthcare data 110 may be pulled from a data source 104 (e.g., pulled by healthcare data server 120 from a point-of-care provider) and/or pushed from a data source (e.g., pushed to healthcare data server 120 by a point-of-care provider on real-time basis). Healthcare data 110 from the disparate transactional data sources may be disposed into respective transactional data warehouses (e.g., database 130) and/or may be subjected to extraction and transformation processes as it navigates through the staging and integration layers to generate integrated data 132, e.g., including longitudinal patient data in a de-identified and secured fashion.

Client devices 106 may include any variety of electronic computing devices. For example, a client device 106 may include one or more of a desktop computer, a laptop computer, a tablet computer, a cellular phone (e.g., a smart phone), a personal digital assistant (PDA), or the like. A client device 106 may include various input/output (I/O) interfaces, such as a graphical user interface (e.g., a display screen), an image acquisition device (e.g., a camera and/or a scanner), an audible output user interface (e.g., a speaker), an audible input user interface (e.g., a microphone), a keyboard/keypad, a pointer/selection device (e.g., a mouse, a trackball, a touchpad, a touchscreen, a stylus, etc.), a printer, and/or the like. In some embodiments, a client device 106 includes general computing components and/or embedded systems optimized with specific components for performing specific tasks. A client device 106 may include applications/modules, including program instructions that are executable by a processor to perform some or all of the functionality described herein with regard to the respective client device 106. Although the client devices 106 are illustrated as single blocks for the purpose of illustration, it will be appreciated that a client device 106 may include a single device (e.g., a single computer) or a plurality of devices (e.g., a plurality of computer devices).

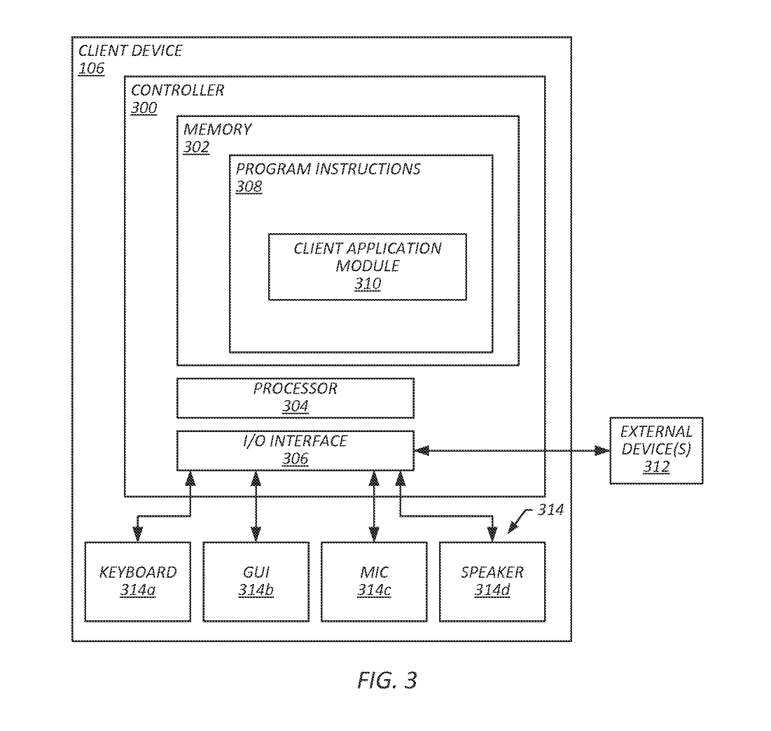

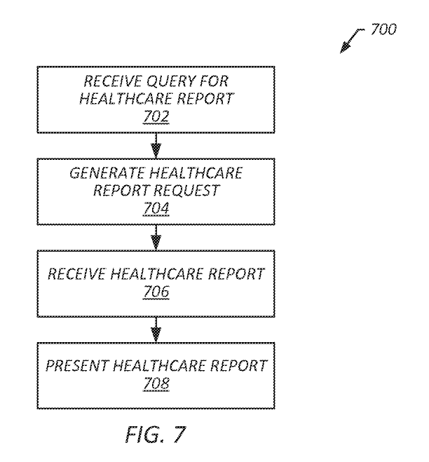

FIG. 3 is a block diagram that illustrates a client device 106 in accordance with one or more exemplary embodiments. In some embodiments, the client device 106 includes a controller 300. Controller 300 may control the operational aspects of the client device 106. In some embodiments, the controller 300 includes a memory 302, a processor 304, and an input/output (I/O) interface 306. Memory 302 may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. Memory 302 may include a non-transitory computer readable storage medium having program instructions 308 stored thereon that are executable by a computer processor (e.g., the processor 304) to cause the functional operations (e.g., methods/routines/processes) described herein with regard to the client device 106. Program instructions 308 may include software modules (e.g., including program instructions) that are executable by the processor 304 to provide some or all of the functionality described herein with regard to the client device 106. Program instructions 308 may include, for example, a client application module 310 (e.g., an internet browser application, or an HI portal application that provides access to the server 120) for performing some or all of the operational aspects of a method 700 (described in more detail below with regard to FIG. 7).

Processor 304 may include one or more of any suitable processor capable of executing/performing program instructions. Processor 304 may include a central processing unit (CPU) that carries out program instructions (e.g., program instructions of the module 310) to perform arithmetical, logical, and input/output operations of client device 106, including those described herein. I/O interface 306 may provide an interface for communication with of one or more I/O devices 314 of the client device 106 and/or the external device(s) 312. I/O devices 314 may include a keyboard 314a, a graphical user interface (GUI) 314b, a microphone 314c, a speaker 314d, and/or the like. External devices 312 may include network servers (e.g., the HI server 120), databases, or other entities communicatively coupled to the client device 106 (e.g., via the network 108). I/O devices 314 and external devices 312 may be connected to the I/O interface 306 via a wired or wireless connection (e.g., via the network 108).

Referring to FIG. 1, the network 108 may include an element or system that facilitates communication between entities of the data network 108. Network 108 may include, for example, an electronic communications network, such as the Internet, a local area network (“LAN”), a wide area (“WAN”), a wireless local area network (“WLAN”), a cellular communications network, and/or the like that facilitates communication between the warehouse 102, the data sources 104, and the clients 106. Network 108 may include a single network or a combination of networks.

During operation, the environment 100 may provide for integration of healthcare data 110 received from one or more disparate data sources 104, and/or provide healthcare reports 114 generated using integrated healthcare data 132. In some embodiments, the HI server 120 (of warehouse 102) receives healthcare data 110 from one or more of data sources 104 and processes the received healthcare data 110 to generate integrated data 132. For example, the HI sever 120 may receive a first set of healthcare data 110 from a source 104a (relating to practitioners' prescriptions of oncology drugs) and receive a second set of healthcare data 110 from another source 104b (relating to patients filling prescriptions of oncology drugs), and so forth. The HI sever 120 may process each of the sets of the raw healthcare data 110 to generate an updated/current version of integrated healthcare data 132. The updated/current version of integrated healthcare data 132 may be stored in one or more databases (e.g., one or more data marts) for future use, such as use in the generation of healthcare reports 114. Integrated data 132 may be regularly/continually updated (e.g., real-time, near real-time, batch processing on a daily, weekly, bi-weekly, or monthly basis, etc.) as new/updated healthcare data 110 is received.

In some embodiments, the HI server 120 (of warehouse 102) generates a healthcare report 114 (e.g., using integrated data 132) in response to receiving a corresponding report request 112 from a client 106. For example, in response to receiving from the client 106a a report request 112 requesting a report indicating what percentage of oncology prescriptions are ultimately filled by patients, the HI server 120 may generate a healthcare report 114 using a current version of the integrated data 132 (e.g., using the version of integrated data 132 based on the recently received first and second healthcare datasets described above), and serve the healthcare report 114 to the client 106a for presentation to user 110.

In some embodiments, the healthcare data 110 is received via a push and/or pull operation. For example, one or more data sources 104 may push the healthcare data 110 to the healthcare informatics server 120 and/or the healthcare informatics server 120 may pull the healthcare data 110 from one or more data sources 104. A push operation may include a data source 104 transmitting healthcare data 110 to the HI server 120, e.g., without receiving a corresponding request from the HI server 120. A pull operation may include the HI server 120 querying a data source 104 for healthcare data 110, and the data source 104 subsequently transmitting the corresponding healthcare data 110 to the HI server 120 in response to the query.

In some embodiments, a data transfer operation is performed on a pre-defined/regular basis. For example, a push and/or pull operation may be performed hourly, daily, weekly, monthly, or the like. If, for example, a data extraction from data source 104a is scheduled to be completed hourly, upon HI server 120 and/or data source 104a determining that the top of the hour has been reached, HI server 120 may perform a pull operation to extract healthcare data 110 from data source 104a and/or data source 104a may perform a push operation to send healthcare data 110 to HI server 120. In some embodiments, a push operation is performed based on the status of the data. For example, a data source 104 may perform a push operation in response to the data source 104 receiving (or otherwise having) new/updated healthcare data 110. As a further example, the HI server 120 may initiate a pull operation (e.g., query the data source 104a for healthcare data 110) in response to the HI server 120 determining that a data source 104 (e.g., data source 104a) has received (or otherwise has) new/updated healthcare data 110. In some embodiments, a pull operation is performed based on the status of the integrated data 132 and/or the receipt of a report request 112. For example, the HI server 120 may initiate a pull operation (e.g., query a data source 104 for healthcare data 110) in response to the HI server 120 receiving a report request 112 and determining that the integrated data 132 needed to respond to the report request 112 is outdated or unavailable. Thus, a push/pull operation may be performed in response to a given event, such as reaching a scheduled time (e.g., end of an hour, day, week or month) and/or determining that new/updated healthcare data is available. In some embodiments, some or all of the extractions of healthcare data 110 (e.g., from clinical, financial and sales transactional data stores) occur at pre-determined intervals (e.g., hourly, daily, weekly and/or monthly). In some embodiments, aggregate data tables can be generated to provide snapshots of data over various periods of time. For example, hourly, weekly, monthly and quarterly aggregate data tables can be created for use in addressing customer requests for information over those periods of time.

In some embodiments, processing the received healthcare data 110 includes staging the data. Staging may include storing the received healthcare data 110 in an intermediate storage area, prior to the data being subjected to subsequent integration processing. For example, the HI server 120 may store received healthcare data 110 in the staging database 129. The healthcare data 110 stored in the staging database 129 may be referred to herein as “staged data” 130. In some embodiments, staging the healthcare data comprises consolidating, aligning, maintaining, standardizing and/or cleansing the healthcare data received from the plurality of disparate data sources. Data standardization may include, for example, converting non-standard payor names coming from disparate transactional data stores into a standardized payor name, converting non-standard gender identifiers coming from disparate transactional data stores into a standardized gender identifier, and/or the like.

In some embodiments, processing the received healthcare data 110 includes integrating the data. Integrating may include combining the various sets of received healthcare data 110 so that the healthcare data 110 can be provided as a single-unified dataset. In some embodiments, integrating data includes normalizing the data. Continuing with the above example, the HI server 120 may normalize both of the sets of staged data 130 (e.g., corresponding to the first and second sets of received healthcare data 110) such that the data can be stored in a unified form. The integrated healthcare data 132 may be stored in the integrated data database 131, and may be referred to herein as “integrated data” 132. In some embodiments, integrating healthcare data includes employing business rules to clean the data, resolve redundancies in the data, and verify integrity of the data.

In some embodiments, processing/integrating the received healthcare data 110 includes associating portions of the integrated data with one or more data marts. A data mart may include a general set of integrated data. For example, all of the integrated data 132 may be stored in (or otherwise associated with) a “general” data mart 131. A data mart may include a subset of integrated data 132 that is associated with a particular subject. For example, a subset of integrated data 132 relating to an oncology drug ABC may be stored in (or otherwise associated with) “oncology drug ABC” data mart 134a. In some embodiments, a data mart may include data associated with a particular industry or client. For example, a subset of integrated data 132 relating to XYZ Pharmaceutical Corporation may be stored in, or otherwise associated with, “XYZ Pharmaceutical Corporation” data mart 134b. In some embodiments, data that is not related to a particular subject is stored in (or otherwise associated with) the general data mart 131. For example, a subset of integrated data 132 relating to patient surveys may be stored in (or otherwise associated with) the general data mart 131 if there are no subject data marts 134 associated with patient survey information.

In some embodiments, integrated data is dynamically updated. For example, the transfer of healthcare data 110 to the HI server 120 (e.g., via the push/pull operations), the staging of the received healthcare data 110, and the integration of the healthcare data 110 may occur independent of receipt of report requests 112, thereby maintaining an up-to-date version of the integrated data 132. That is, in some embodiments, the integrated data 132 is continually/regularly updated, and is not updated only as a result of servicing a report request 112. Such dynamic updating of integrated data 132 may significantly reduce the lead-time needed to generate healthcare reports 114 a current, up-to-date version of the integrated data 132 is readily available for use in generating healthcare reports 114. The ability to quickly access and process the current version of the integrated data 132 may enable healthcare reports 114 to be provided on-demand (e.g., within seconds or minutes of a user submitting the corresponding request for the report 114).

In some embodiments, healthcare reports 114 relating to a given subject are generated using integrated data 132 of particular data marts 134 associated with the subject. Continuing with the above example, in response to receiving from the client 106a a report request 112 requesting a report on the percentage of prescriptions for oncology drug ABC that are ultimately filled by patients, the HI server 120 may generate a healthcare report 114 using the integrated data 132 of “oncology drug ABC” data mart 134a. In some embodiments, reports 114 for/from an entity may be serviced using a data mart 134 associated with the entity. For example, if the client 106b is associated with XYZ Corporation and data mart 134b includes information for XYZ Corporation (e.g., has a subject of “XYZ Corporation”), in response to receiving a request for a report from the client 106b associated with XYZ Corporation, the HI server 120 may generate a corresponding report 114 using the data in the data mart 134b. In some embodiments, a data mart 134 associated with an entity may be reserved for responding to requests associated with the entity, and may not be used to service requests for/by other entities. For example, if the client 106b is associated with XYZ Corporation, the data mart 134b includes information reserved for XYZ Corporation (e.g., has a subject of “XYZ Corporation”), the client 106c is associated with QRS Corporation and the data mart 134c includes information reserved for QRS Corporation (e.g., has a subject of “QRS Corporation”), the HI server 120 may use the data in the data mart 134b to generate a report for the client 106b, but may not use the data in the data mart 134b to generate a report for the client 106c. Further, the HI server 120 may use the data in the data mart 134c to generate a report for the client 106c, but may not use the data in the data mart 134c to generate a report for the client 106b.

In some embodiments, healthcare reports 114 include a detailed assessment of clinical, reimbursement, and/or claims data. Healthcare reports 114 may include market share reports (e.g., relating to drug utilization, competitive intelligence, and/or the like), patterns of care reports, treatment sequencing reports (e.g., using longitudinal patient data), reimbursement trend reports, denial/time-to-payment trend reports and so forth.

In some embodiments, healthcare reports 114 are provided on-demand. Providing a healthcare report 114 on-demand may include providing a healthcare report 114 for presentation to a user during the same user session in which the corresponding request for the report is submitted. For example, a user 110 may login to a healthcare portal application on the client device 106a (to initiate a user session), the user 110 may submit (via the healthcare portal application) a query for a report regarding the percentage of prescriptions for oncology drug ABC that are ultimately filled by patients during a particular period of time, and the client device 106a may transmit a corresponding report request 112 to the HI server 120. In response to receiving the corresponding report request 112 from the client device 106a, the HI server 120 may generate a healthcare report 114 using the integrated data 132 and transmit the healthcare report 114 to the client device 106a for presentation to the user 110. In some embodiments, the healthcare report 114 is served on-demand, within seconds or minutes of the HI server 120 receiving the report request 112. In response to receiving the healthcare report 114, the client device 106a may render the report for display to the user 110 during the same user session in which the corresponding request for the report was submitted by the client device 106a. In such embodiments, the user 110 may not have to wait days, weeks or even months to receive the requested healthcare report 114.

In some embodiments, presenting a healthcare report 114 includes presenting an interactive healthcare report. An interactive healthcare report may enable a user to change one more report requirements, and provide for the display of an updated healthcare report that corresponds to the new report requirements. For example, a user 110 may be provided with a display of an interactive healthcare report 114 illustrating the percentage of prescriptions for oncology drug ABC that were ultimately filled by patients from Jan. 1, 2010 to Dec. 31, 2013. The user 110 may change the relevant time frame to Jan. 1, 2012 to Dec. 31, 2013, at the client device 106a and the healthcare report 114 may be dynamically updated by the HI server 120 to illustrate the percentage of prescriptions for oncology drug ABC that were ultimately filled by patients from Jan. 1, 2012 to Dec. 31, 2013. Any variety of reports can be generated in a similar manner. For example, while viewing the interactive healthcare report 114, user 110 may request and receive a new report for the number of patients that have been prescribed oncology drug ABC in 2014.

In some embodiments, the dynamic update is facilitated via a corresponding report request 112. For example, (1) the client device 106a may submit a first report request 112 for the percentage of prescriptions for oncology drug ABC that were ultimately filled by patients from Jan. 1, 2010 to Dec. 31, 2013, to the HI server 120, (2) the client device 106a may receive a corresponding healthcare report 114 from the HI server 120, (3) the client device 106a may display an interactive version of the healthcare report 114 via a graphical user interface (GUI) of the client device 106a, (4) the client device 106a may receive user selection (e.g., a selection by the user 110 via an interactive GUI of the client 106a) to change the relevant time frame to Jan. 1, 2012 to Dec. 31, 2013, (5) the client device 106a may submit a second report request 112 (for the percentage of prescriptions for oncology drug ABC that were ultimately filled by patients from Jan. 1, 2012 to Dec. 31, 2013) to the HI server 120, (6) the client device 106a may receive a corresponding “updated” healthcare report 114 (including information regarding the percentage of prescriptions for oncology drug ABC that were ultimately filled by patients from Jan. 1, 2012 to Dec. 31, 2013) from the HI server 120, (7) the client device 106a may display an interactive version of the “updated” healthcare report 114 via the graphical user interface (GUI) of client device, (8) the client device 106a may receive user selection requesting a report on the number of patients that have been prescribed oncology drug ABC in 2014, (9) the client device 106a may submit a third report request 112 (for the number of patients that have been prescribed oncology drug ABC in 2014) to the HI server 120, (10) the client device 106a may receive a corresponding “new” healthcare report 114 (including information regarding the number of patients that have been prescribed oncology drug ABC from Jan. 1, 2014 to Dec. 31, 2014) from the HI server 120, and (11) the client device 106a may display an interactive version of the “new” healthcare report 114 via the graphical user interface (GUI) of client device 106a.

Those of ordinary skill in the art will appreciate that the environment 100 shown in and described with respect to FIG. 1 is provided by way of example only. Numerous other operating environments, system architectures, and device and network configurations are possible. Other system embodiments can include fewer or greater numbers of components and may incorporate some or all of the functionality described with respect to the system components shown in FIGS. 1-3. For example, at least a portion of the functions of modules 210a, 210b, and 210c may be implemented by a client device 106 (e.g., by module 310 and processor 304), and/or vice versa, at least a portion of the functions of the module 310 may be implemented by the HI server 120 (e.g., by modules 210a, 210b and/or 210c and the processor 204). Accordingly, embodiments of the disclosure should not be construed as being limited to any particular operating environment, system architecture, or device or network configuration.

Operational Overview

FIG. 4 is a flowchart that illustrates a method 400 of managing healthcare informatics information in accordance with one or more exemplary embodiments. The method 400 generally includes processing received healthcare data (block 406) in response to determining that healthcare data has been received (block 402), and servicing a healthcare report request (block 410) in response to determining that a healthcare report request has been received (block 408). The process may continue until a request to end the process is received (block 412). In some embodiments, some or all of the operational aspects of method 400 are performed by the HI server 120. For example, some or all of the operational aspects of method 400 may be performed by the management module 210a.

In some embodiments, determining whether healthcare data has been received (block 402) includes determining whether the healthcare data 110 has been received by the HI server 120 from one or more of data sources 104. For example, it may be determined that the healthcare data 110 has been received if the data source 104a transmits (and the HI server 120 receives) the healthcare data 110 (e.g., via the network 108) indicative of, for example, the number of prescriptions for oncology drug ABC that were ultimately filled by patients in June of 2014. It may be determined that healthcare data has not been received if the HI Sever 120 has not received data from any of the data sources 104.

In some embodiments, the method 400 includes processing the received healthcare data (block 406) (e.g., in response to determining that healthcare data 110 has been received from one or more of the data sources 104 by the HI server 120). Processing the received data may include staging the received data, integrating the received data, and/or generating data marts for relevant subjects and allocating/storing the received healthcare data 110 into the one or more data marts.

FIG. 5 is a flowchart that illustrates a method 500 of processing received healthcare data in accordance with one or more exemplary embodiments. The example method 500 generally includes staging healthcare data (block 502), integrating healthcare data (block 504), and generating subject data marts (block 508) in response to determining that the integrated healthcare data 132 includes data relevant to one or more subjects (block 506). In some embodiments, some of all of the operational aspects of the method 500 are performed by the HI server 120. For example, some or all of the operational aspects of the method 500 may be performed by the integration module 210b.

In some embodiments, staging healthcare data (block 502) includes storing the received healthcare data 110 in an intermediate storage area, prior to the data being subjected to subsequent integration processing. Continuing with the above example, the HI server 120 may store first and second sets of healthcare data 110 in the staging database 129 as staged data 130.

In some embodiments, integrating healthcare data (block 504) includes combining various sets of received healthcare data 110 so that the healthcare data 110 can be provided as a single-unified dataset. In some embodiments, integrating data includes normalizing the data. Continuing with the above example, the HI server 120 may normalize both of the first and second sets of staged data 130 such that the data can be stored in a unified form. The integrated healthcare data 132 may be stored in the integrated data database 131 as integrated data 132.

In some embodiments, determining whether integrated healthcare data includes data relevant to one or more subjects (block 506) includes determining whether the integrated healthcare data 132 includes data relevant to one or more predefined subjects. For example, if predefined subjects include “oncology drug ABC” and “XYZ Pharmaceutical Corporation,” determining whether the integrated healthcare data 132 includes data relevant to one or more subjects includes determining whether integrated healthcare data 132 includes data associated with “oncology drug ABC” and “XYZ Pharmaceutical Corporation.” It may be determined that the first set of integrated healthcare data 132 includes data relevant to “oncology drug ABC” if, for example, the first set of integrated healthcare data 132 includes information relating to the number of prescriptions for oncology drug ABC that were ultimately filled by patients in June of 2014.

In some embodiments, generating a data mart for a subject (block 508) includes generating (or otherwise updating) a data mart 134 associated with the subject. If, for example, the first set of integrated healthcare data 132 includes information relating to the number of prescriptions for oncology drug ABC that were ultimately filled by patients in June of 2014, generating a data mart for a subject may include creating/updating “oncology drug ABC” data mart 134a to include the information relating to the number of prescriptions for oncology drug ABC that were ultimately filled by patients in June of 2014.

Referring again to the method 400 of FIG. 4, in some embodiments, determining whether a healthcare report request has been received (block 408) includes determining whether the HI server 120 has received a healthcare report request 112 from one or more of client devices 106. For example, it may be determined that a healthcare report request has been received if the client device 106a transmits (and the HI server 120 receives) a report request 112 requesting information regarding the percentage of prescriptions for oncology drug ABC were ultimately filled by patients from Jan. 1, 2010 to Dec. 31, 2013. In some embodiments, a healthcare report request may be generated independent of a client device 106. For example, ABC corporation may have a standing/reoccurring request for a monthly report on the percentage of prescriptions for oncology drug ABC were ultimately filled by patients in the preceding month. Thus for example, on the first day of each month healthcare informatics server 120 may automatically generate a report request 112 that requests a report on the percentage of prescriptions for oncology drug ABC were ultimately filled by patients in the preceding month. The internal generation/receipt of the report request may initiate generation of a corresponding report 114 in a similar manner as receiving a request from a client device 106.

In some embodiments, servicing a healthcare report request 112 (block 410) includes determining whether the report request 112 is relevant to one or more subjects, and, if it determined that the report request is relevant to one or more subjects, identifying data mart(s) associated with the subject(s), generating a healthcare report using the healthcare data of the data mart(s) associated with the subject(s), and transmitting the healthcare report (e.g., to the client 106a via the network 108 for display to the user 110). Servicing a report request may also include, if it is determined that the report request is not relevant to a subject, identifying relevant healthcare data for the report (e.g., from the general data mart 131), generating a healthcare report using the relevant healthcare data, and transmitting the healthcare report (e.g., to the client 106a for display to the user 110).

FIG. 6 is a flowchart that illustrates a method 600 of servicing a healthcare report request 112 in accordance with one or more exemplary embodiments. The method 600 generally includes determining whether the report request 112 relates to one or more subjects (block 602). If it is determined that the report request 112 relates to one or more subjects, identifying data mart(s) associated with the subject(s) (block 604). The method 600 can also include generating a healthcare report using the healthcare data of the data mart(s) associated with the subject(s) (block 606), and transmitting the healthcare report (block 612). The method 600 also generally includes, if it is determined that the report request is not related to a subject (block 602), identifying healthcare data relevant to the requested healthcare report (block 608), generating a healthcare report using the healthcare data identified as being relevant to the requested healthcare report (block 610), and transmitting the healthcare report (block 612). In some embodiments, some of all of the operational aspects of the method 600 are performed by the HI server 120. For example, some or all of the operational aspects of the method 600 may be performed by the reporting module 210c.

In some embodiments, determining whether a report request relates to a subject (block 602) includes determining whether a report request 112 is relevant to one or more subjects associated with one or more of the subject data marts 134. For example, if the subject data mart 134a is associated with “oncology drug ABC,” and a first report request 112 requests information regarding the percentage of prescriptions for oncology drug ABC that were ultimately filled by patients from Jan. 1, 2010 to Dec. 31, 2013, it may be determined that the first report request 112 is related to at least the subject of “oncology drug ABC” associated with data mart 134a. As a further example, if a second report request 112 requests information regarding the percentage of prescriptions for oncology drug LMN that were ultimately filled by patients from Jan. 1, 2010 to Dec. 31, 2013, and none of the subject data marts 134 are associated with “oncology drug LMN,” it may be determined that the second report request 112 is not related to a subject for which a data mart 134 has been created.

In some embodiments, identifying data mart(s) associated with subject(s) (block 604) includes identifying the subject data mart(s) 134 associated with the subject of the report request 112. For example, continuing with the subject of the first report request 112 (requesting information regarding the percentage of prescriptions for oncology drug ABC that were ultimately filled by patients from Jan. 1, 2010 to Dec. 31, 2013) the subject data mart 134a may be identified as being associated with the subject of the first report request 112. In some embodiments, multiple subject data marts 134 can be identified as being associated with a request.

In some embodiments, generating a healthcare report using the healthcare data of the data mart(s) associated with the subject (block 606) includes using the integrated data 132 included in the subject data mart(s) 134 associated with the subject(s) and/or other integrated data 132 (e.g., integrated data 132 of the general data mart 131 that is not in the related subject data marts 134) to generate the requested healthcare report 114. For example, continuing with the above example in which it is determined that a first report request 112 (requesting information regarding the percentage of prescriptions for oncology drug ABC that were ultimately filled by patients from Jan. 1, 2010 to Dec. 31, 2013) is associated with the subject of “oncology drug ABC” associated with the data mart 134a, the HI server 120 may access and use integrated data 132 of “oncology drug ABC” data mart 134a to generate a first healthcare report 114 that is responsive to the first report request 112 (e.g., generate a report indicating the percentage of prescriptions for oncology drug ABC that were ultimately filled by patients from Jan. 1, 2010 to Dec. 31, 2013). In some embodiments, the healthcare report 114 may be supplemented with other integrated data 132 (e.g., supplemented with integrated data 132 of general data mart 131 that is not in the related subject data marts 134). For example, if the report requires information that resides outside of “oncology drug ABC” data mart 134a (e.g., in another subject data mart 134, or in the integrated data 132 of the general data mart 131), the HI server 120 may access and use a combination of the integrated data 132 from the subject data mart associated with the subject of the request (e.g., “oncology drug ABC” data mart 134a), and the integrated data 132 of another subject data mart 134 and/or the general data mart 131 to generate a first healthcare report 114 that is responsive to the first report request 112. Identifying subject data marts 134 having the integrated data 132 that can be used to generate a requested healthcare report may help to decrease the processing burden (and thereby reduce the lead-time) to generate a healthcare report 114, as the report generation process can focus processing on only a subset of the integrated data 132.

In some embodiments, identifying healthcare data relevant to the requested healthcare report 114 (block 608) includes identifying portions of the integrated data 132 that are relevant to a requested healthcare report 112. For example, continuing with the above example in which it is determined that a second report request 112 (requesting information regarding the percentage of prescriptions for oncology drug LMN that were ultimately filled by patients from Jan. 1, 2010 to Dec. 31, 2013) is not associated with a subject associated with any of data marts 134, HI server 120 may identify portions of integrated data 132 that can be used to service the request. This may include, for example, identifying portions of integrated data 132 of the general data mart 131 and/or subject data marts 134 that is related to oncology drug LMN.

In some embodiments, generating a healthcare report using the healthcare data of the data mart(s) associated with the subject (block 610) includes generating the requested healthcare report 114 using the integrated data 132 identified as relevant to the requested healthcare report 114. For example, continuing with the above example including a second report request 112 (requesting information regarding the percentage of prescriptions for oncology drug LMN that were ultimately filled by patients from Jan. 1, 2010 to Dec. 31, 2013), the HI server 120 may access and use integrated data 132 identified as being related to the oncology drug LMN to generate a second healthcare report 114 that is responsive to the second report request 112 (e.g., a report indicating the percentage of prescriptions for oncology drug LMN that were ultimately filled by patients from Jan. 1, 2010 to Dec. 31, 2013).

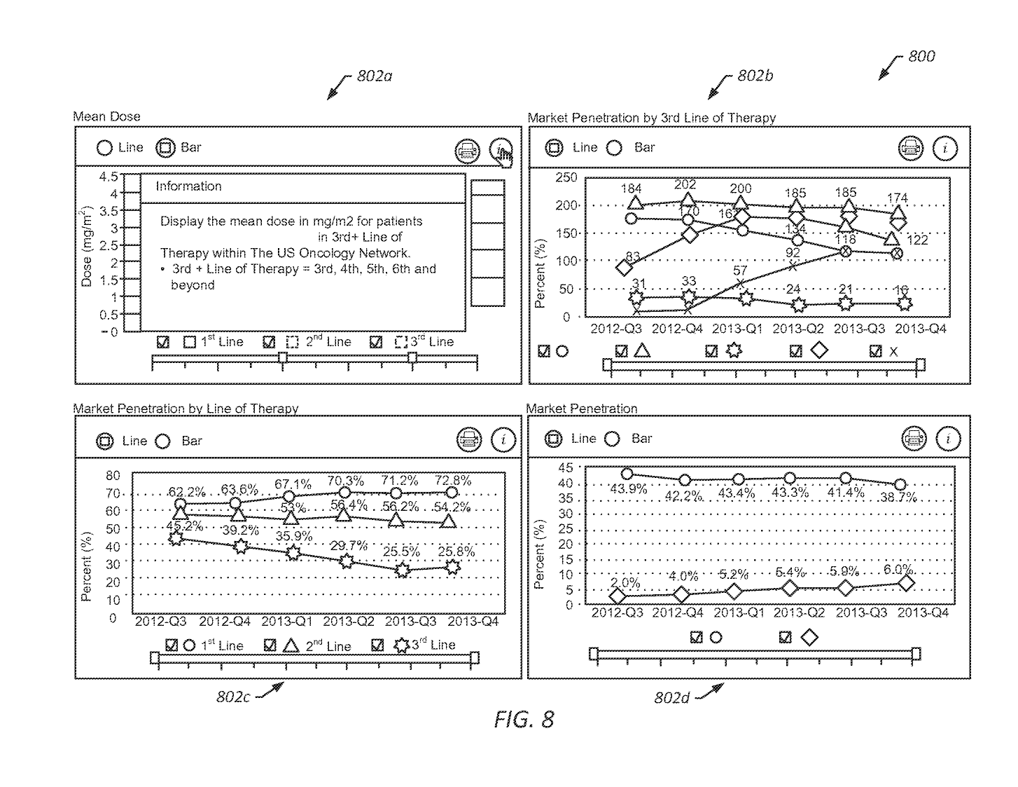

In some embodiments, transmitting a healthcare report 114 (block 612) includes transmitting the generated healthcare report 114 to a client 106 for presentation to a user 110. Continuing with the above example, in response to the HI server 120 receiving the first report request 112 (requesting information regarding the percentage of prescriptions for oncology drug ABC that were ultimately filled by patients from Jan. 1, 2010 to Dec. 31, 2013), the HI server 120 may generate an electronic version of the requested healthcare report 114 (e.g., a report indicating the percentage of prescriptions for oncology drug ABC that were ultimately filled by patients from Jan. 1, 2010 to Dec. 31, 2013), and transmit the electronic version of the requested healthcare report 114 (e.g., via the network 108) to the client 106a for display to the user 110. In some embodiments, the report 114 is generated in real-time or near real-time (within seconds or minutes) and is transmitted to the client in real-time or near real-time (within seconds or minutes) so that healthcare report 114 is presented to the user 110 on-demand (e.g., presented to the user within seconds or minutes of the associated healthcare report request 112). The resulting report 114 may be presented to the user 110 during the same user session in which corresponding healthcare report request 112 was generated by user 110. Exemplary healthcare reports are described in more detail herein with regard to at least FIG. 8

FIG. 7 is a flowchart that illustrates a method 700 of processing a healthcare report request in accordance with one or more exemplary embodiments. The method 700 generally includes receiving a query for a healthcare report (block 702), generating a healthcare report request (block 704), receiving the healthcare report (block 706), and presenting the healthcare report (block 708). In some embodiments, some of all of the operational aspects of the method 700 are performed by a client device 106. For example, some or all of the operational aspects of the method 700 may be performed by the client application module 310.

In some embodiments, receiving a query for a healthcare report (block 702) includes a client device 106 receiving a user submitted request 112 for a healthcare report 114. For example, receiving a query for a healthcare report may include the client device 106a receiving, from the user 110 (e.g., via a HI reporting application running on the client device 106a), a request for information regarding the percentage of prescriptions for oncology drug ABC that were ultimately filled by patients from Jan. 1, 2010 to Dec. 31, 2013.

In some embodiments, generating a healthcare report request (block 704) includes a client device 106 transmitting a request for a healthcare report 112 to the HI server 120. Continuing with the above example, generating a healthcare report request 112 may include the HI reporting application (running on the client device 106a) causing the client device 106a to transmit (e.g., via the network 108) the healthcare report request 112 that requests information regarding the percentage of prescriptions for oncology drug ABC that were ultimately filled by patients from Jan. 1, 2010 to Dec. 31, 2013.

In some embodiments, receiving the healthcare report 114 (block 706) includes a client device 106 receiving a corresponding a healthcare report 114. Continuing with the above example, receiving the healthcare report may include the client device 106a receiving (e.g., via the network 108) a healthcare report 114 (e.g., including information regarding the percentage of prescriptions for oncology drug ABC that were ultimately filled by patients from Jan. 1, 2010 to Dec. 31, 2013) that was generated and transmitted by the HI server 120. The healthcare report 114 may be passed to the HI reporting application running on the client device 106a.

In some embodiments, presenting the healthcare report (block 708) includes presenting the healthcare report 114 to a user 110. For example, continuing with the above example, presenting the healthcare report 114 may include the HI reporting application (running on client device 106a) rendering the received healthcare report 114 for display to a user 110 via a graphical user interface (GUI) of the client device 106a. Thus, the user 110 may be presented with a report 114 including information regarding the percentage of prescriptions for oncology drug ABC that were ultimately filled by patients from Jan. 1, 2010 to Dec. 31, 2013). In some embodiments, presenting the healthcare report 114 may include presenting an interactive report 114 as discussed herein.

FIG. 8 is a diagram that illustrates a healthcare report 800 in accordance with one more exemplary embodiments. As depicted, the healthcare report 800 includes a first region 802a illustrating a mean dose for patients, a second region 802b including a chart illustrating market penetration for a 3^{rd} line of therapy, a third region 802c including a chart illustrating market penetration by line of therapy, and a fourth region 802d including a chart illustrating market penetration. It will be appreciated that healthcare report is exemplary, and any variety of reports can be provided. For example, continuing with the above example of a first request 112 (including a request for information regarding the percentage of prescriptions for oncology drug ABC that were ultimately filled by patients from Jan. 1, 2010 to Dec. 31, 2013), a displayed report may include a chart that illustrates the percentage of prescriptions for oncology drug ABC that were ultimately filled for each of the 36 months from January 2010 to December 2013.

It will be appreciated that the methods 400, 500, 600, and 700 are exemplary embodiments of methods that may be employed in accordance with techniques described herein. The methods 400, 500, 600, and 700 may be modified to facilitate variations of its implementations and uses. The order of the methods 400, 500, 600, and 700 and the operations provided therein may be changed, and various elements may be added, reordered, combined, omitted, modified, etc. The methods 400, 500, 600, and 700 may be implemented in software, hardware, or a combination thereof. Some or all of the methods 400, 500, 600, and 700 may be implemented by one or more of the modules/applications described herein.

Many modifications and other embodiments of the disclosure set forth herein will be apparent having the benefit of the teachings presented in the foregoing descriptions and the associated drawings. Therefore, it is to be understood that the claims are not to be limited to the specific embodiments disclosed and that modifications and other embodiments are intended to be included within the scope of the appended claims. Although specific terms are employed herein, they are used in a generic and descriptive sense only and not for purposes of limitation.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” may include a combination of two or more elements. As used throughout this application, the phrase “based on” does not limit the associated operation to being solely based on a particular item. Thus, for example, processing “based on” data A may include processing based at least in part on data A and based at least in part on data B unless the content clearly indicates otherwise. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

That which is claimed:

1. A healthcare data warehouse, comprising:
a healthcare database comprising one or more subject data marts, wherein a subject data mart is associated with one or more subjects; and
a healthcare informatics server configured to:
dynamically maintain a healthcare data mart, the maintaining comprising:
receiving, via a network, healthcare data from a plurality of disparate healthcare data sources;
staging the healthcare data received from the plurality of disparate healthcare data sources to generate staged healthcare data;
integrating the staged healthcare data to generate integrated healthcare data; and
storing the integrated data in the healthcare database, wherein storing the integrated healthcare data in the healthcare database comprises:
identifying one or more subsets of the integrated data related to one or more subjects; and
for each of the one or more subsets of the integrated data related to one or more subjects, storing the subset of the integrated data in one or more subject data marts of the healthcare database that are associated with the subject;
provide, in response to receiving a request for a healthcare report from a client device, a healthcare report, the providing comprising:
identifying one or more subjects corresponding to the requested healthcare report;
identifying one or more subject data marts associated with the one or more subjects corresponding to the requested healthcare report;
generating a healthcare report using the data in the one or more subject data marts identified; and
serve, to a client device for presentation to a user, the healthcare report.

2. A computer-implemented method, comprising:
dynamically maintaining a healthcare data mart comprising:
receiving, from a plurality of disparate data sources, healthcare data;
integrating the healthcare data to generate integrated healthcare data; and
storing, in a healthcare database, the integrated healthcare data; and
providing, in response to receiving a request for a healthcare report from a client device, a healthcare report, the providing comprising:
generating, using the integrated healthcare data, a healthcare report responsive to the request; and
serving, to the client device, the healthcare report.

3. The method of claim 2, wherein receiving healthcare data from a plurality of disparate healthcare data sources comprises:
determining that predetermined time has been reached; and
performing, in response to determining that the predetermined time has been reached, a pull operation to extract healthcare data from one or more of the plurality of disparate healthcare data sources.

4. The method of claim 2, wherein receiving healthcare data from a plurality of disparate healthcare data sources comprises:
determining that new healthcare data is available from one or more of the plurality of disparate healthcare data sources; and
performing, in response to determining that new healthcare data is available from one or more of the plurality of disparate healthcare data sources, a pull operation to extract the new healthcare data from the one or more of the plurality of disparate healthcare data sources.

5. The method of claim 2, wherein dynamically maintaining one or more healthcare data marts is performed independent of receipt of requests for healthcare reports.

6. The method of claim 2, wherein dynamically maintaining one or more healthcare data marts is performed prior to receiving the request for a healthcare report.

7. The method of claim 2, wherein integrating the healthcare data comprises cleansing the data, resolving redundancies in the data, and verifying integrity of the data.

8. The method of claim 2, wherein dynamically maintaining a healthcare data mart comprises:
staging the received healthcare data to generate staged healthcare data, and
wherein integrating the healthcare data to generate integrated healthcare data comprises integrating the staged healthcare data to generate integrated healthcare data.

9. The method of claim 2, wherein staging the healthcare data comprises consolidating, aligning, maintaining, standardizing and cleansing the healthcare data received from the plurality of disparate data sources.

10. The method of claim 2, wherein providing a healthcare report comprises providing a healthcare report on-demand for display to a user during the same user session used to initiate the request for the healthcare report.

11. The method of claim 2, wherein the healthcare data comprises oncology data.

12. The method of claim 2,
wherein dynamically maintaining a healthcare data mart comprises:
generating at least one subject data mart, wherein a subject data mart comprises a portion of the integrated healthcare data related to a given subject; and
storing, in the healthcare database, the at least one subject data mart,
wherein the request for a healthcare report pertains to a subject, and
wherein providing a healthcare report comprises:
identifying, from the at least one subject data marts, one or more subject data marts that pertain to the subject of the request,
wherein generating a healthcare report responsive to the request comprises generating, using the integrated healthcare data of the one or more subject data marts identified, a healthcare report responsive to the request.

13. The method of claim 2, wherein the healthcare report comprises an interactive healthcare report.

14. The method of claim 13, further comprising:
receiving an updated healthcare report request indicative user selection of updated requirements for the healthcare report from the client device;
providing, in response to receiving the updated healthcare report request, an updated healthcare report, the providing comprising:
generating, using the integrated healthcare data, an updated healthcare report responsive to the request; and
serving, to the client device, the updated healthcare report.

15. The method of claim 14, wherein the healthcare report and the updated healthcare report are provided for display to a user during the same user session used to initiate the request for the healthcare report.

16. The method of claim 2, wherein the plurality of data sources comprise two or more of the following data sources: a claims/remittance data source, an inventory management system data source, an electronic health/medical record (HMR or EMR) data source, a pharmacy management system data source, or sales and distribution data source.

17. The method of claim 2, wherein the healthcare data comprises one or more of the following types of data: medication dispense records, electronic health/medical records (HMR or EMR), clinic payment records, clinic charges records, or practice in-office dispense records.

18. The method of claim 2, wherein the healthcare data comprises oncology data.

19. A system comprising:
at least one memory comprising computer-executable instructions stored thereon; and
at least one processor configured to access the at least one memory and execute the computer-executable instructions to:
dynamically maintain a healthcare data mart comprising:
receiving, from a plurality of data sources, healthcare data;
integrating the healthcare data to generate integrated healthcare data; and
storing, in a healthcare database, the integrated healthcare data; and
provide, in response to receiving a request for a healthcare report from a client device, a healthcare report, the providing comprising:
generating, using the integrated healthcare data, a healthcare report responsive to the request; and
serving, to the client device, the healthcare report.
